(19) United States
(12) Patent Application Publication
(10) Pub. No.: US 2007/0112878 A1
(43) Pub. Date: May 17, 2007

(54) Computer method and system for coherent source and target model transformation

(75) Inventors: Nicholas G. Bennett, Ottawa (CA); Maneesh Goyal, Kanata (CA); Daniel D. Leroux, Kanata (CA)

Correspondence Address: HAMILTON, BROOK, SMITH & REYNOLDS, 530 VIRGINIA ROAD, PO BOX 9133, CONCORD, MA, 01742-9133, US

(73) Assignee: International Business Machines Corporation, Armonk, NY (US)

(21) Appl. No.: 11/271,277

(22) Filed: Nov. 11, 2005

(51) Int. Cl. G06F 17/30

(52) U.S. Cl. 707/201

(57) ABSTRACT

A change-set validator is invoked at the end of every transaction on a target model. The change-set validator may also be used as a transaction committer wherein after validating the change-set, changes are made to the source model, thereby bringing both models in sync. A Transformation Adapter deals with transformation of source meta-model objects to target meta-model objects. The Inverse Transformation Adapter is a special case of the change-set validator used also as the transaction committer, and deals with transformation of target meta-model objects to source meta-model objects. The change-set validator can be implemented as a rule. The change-set committer can be implemented as a Semantic Procedure.

### BACKGROUND OF THE INVENTION

In the software industry, the design of software components or products typically begins with an assessment of customer's needs and goals combined with an analysis of any existing system into which the software will be deployed. Modeling techniques are commonly employed in conjunction with this assessment to document and formalize the incoming customer requirements into a specification of the required structural and behavioral semantics of the new software. In addition, the analysis of the existing system's semantic specification can be similarly represented using the same modeling techniques. A modeling language, such as UML defines a standard grammar that allows the software developer to document the observed semantics of the existing system in a way that is complete and verifiably consistent with the implementation but that is sufficiently abstracted that it does not require in-depth knowledge of the details of the implementation or deployment. This means that a significant amount of information about the target system (including some information about the existing solution implementations) is captured in a format that allows the developer to leverage powerful object-oriented concepts in analysis and design (such as extension of existing API artifacts) during the iterative analysis and design process for software development.

One such concept is a Model to Model Transformation. A Model to Model Transformation allows the transformation of any Source Model (containing source elements) based on any arbitrary Source meta-model to Target Models based on some equally arbitrary Target meta-model provided that a mapping is defined from the source meta-model to the target meta-model.

Existing technologies applying such transformations from an arbitrary source element to a target model must also transform all children of that source element as well as any source elements that are referenced by any element being transformed. This algorithm is recursive thus any element transformed from the source model results in the transformation of its children and references.

In products or solutions involving such Model to Model transformations, where source and target models are kept coherent at all times, there are two common problems—(1) how to enforce the semantics of the source meta-model on the target meta-model and (2) how to change the source model whenever the target model changes. To explain theses problems further, assume a source meta-model 11 and a target meta-model 13 with mappings as shown in FIG. 1.

Further assuming that a model “S” based on Source meta-model is transformed to a target model “T” based on Target meta-model. Model S has one instance saobj of meta class SA 15 that is transformed to taobj, an instance of meta class TA 17.

Assume that the client of the target model adds a reference to an instance of TB 19 (tbobj) in taobj. Since both source model S and target model T are kept coherent at all times, this change to T should be reflected in S. So in the source model S, saobj should reflect the change done to the target model. Similarly addition of an instance of TC 21 to meta class TA 17 should be invalidated.

In the assumed target meta-model 13, meta class TC 21 and feature ‘containTac’ of meta class TA 17 do not have any mapping from source meta-model 11. Assuming, model ‘S’ based on Source meta-model 11 is transformed to a model T based on Target meta-model 13, if both models are to be kept coherent at all times, then the target meta-model 13 should never contain an instance of meta class TC 21 in feature ‘containTac’. After the transformation is complete, if some external agent tries to modify model T to add an instance of TC 21 contained in TA 17 as ‘containTac’, that modification should be invalidated, provided there is no mechanism to reflect this information in the source meta-model 11.

Existing solutions use peripheral techniques, like feature blocking at the graphical user interface (GUI) level, to achieve the coherent transformed models. These techniques to block the modification of the target model provide a limited solution around the target model, and special handling is required for models that are a result of some transformation.

In other solutions a graphical user interface (GUI) tool involved in changing the target model also changes the source model. The changes that are invalid for the source model are not allowed in the target model at the GUI layer. Some solutions provide explicit committing tools (users invoke at will) to bring source and target models in coherent state.

### SUMMARY OF THE INVENTION

The present invention provides a solution to the problems of the prior art. In particular, the present invention provides:

(1) Validation of a change in a transaction. If a change is done to a model based on target meta-model and cannot be propagated to a model based on the source meta-model, the change is determined not to be a valid change and the transaction is invalidated. Invalid changes in a transaction cannot be partially committed to the model based on source meta-model. Thus invalid changes are avoided, omitted or otherwise voided in both the target and source models.

(2) Committing the change done in a transaction. If the change done to a model based on target meta-model is a valid change, then the change is transformed to a corresponding source meta-model change and committed to the source model.

(3) In the preferred embodiment, this process (validation and committing) is implemented at transaction and batch level.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic illustration of a source meta-model to target meta-model mapping in a model-to-model transformation.

FIG. 2 is a schematic illustration of change set validation and transaction committing of a preferred embodiment of the present invention.

FIG. 3 is a block diagram of the change set committer of the FIG. 2 embodiment.

FIG. 4 is a schematic view of a computer network in which embodiments of the present invention may be deployed.

FIG. 5 is a block diagram of a computer node in the computer network of FIG. 4.

### DETAILED DESCRIPTION OF THE INVENTION

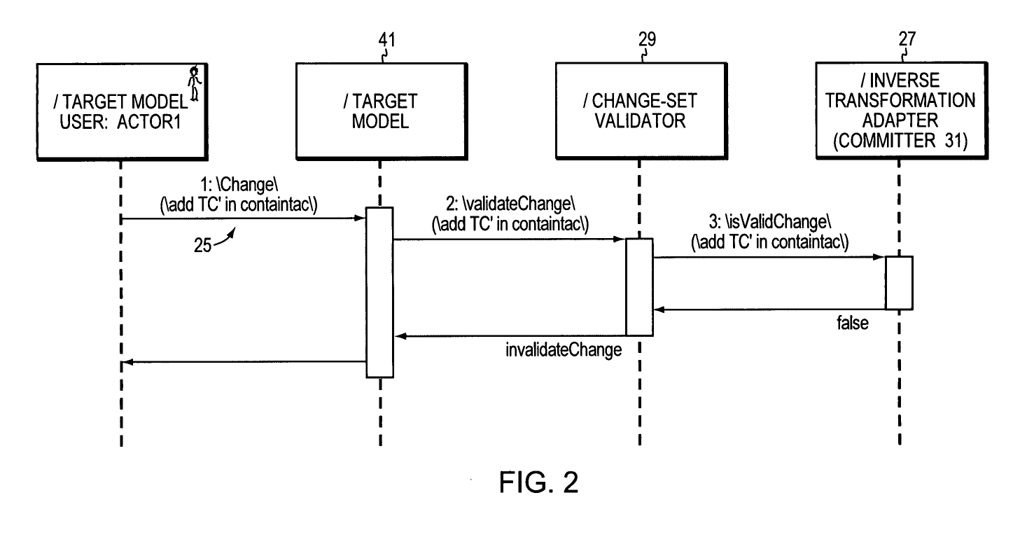

To solve the problems described above, the present invention proposes using a Change-Set Validator 29 (FIG. 2) to invalidate the changes to a target model 41 and a Committer 31 to commit validated changes to the source model 39. The Change-Set Validator 29 and Committer 31 are invoked at the end of every transaction on the target model 41. A “transaction” is defined as one unit of modification to the target model 41 and changes that happen in one transaction construct a “change-set”. If the Validator 29 invalidates the changes done in the transaction, then the transaction is rolled back (so changes made to target model 41 are reversed or undone), else the Committer 31 commits the changes to the source model 39.

A special implementation of Change-Set Validator 29 can also be used as a transaction Committer 31, where after validating the change-set, changes are made to the source model 39, thereby bringing both models 39, 41 in sync (coherent bidirectionally). This special implementation of Change-Set Validator 29 and transaction Committer 31 is referred to herein as the Inverse Transformation Adapter 27 (FIG. 2).

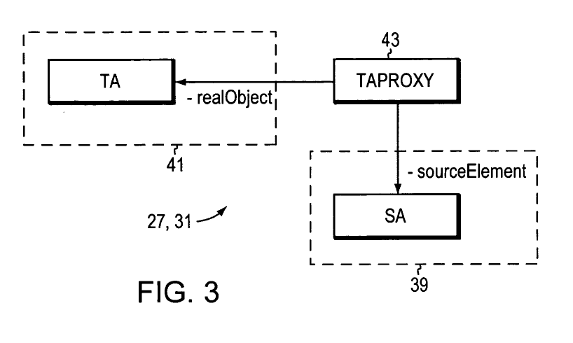

Unlike a Transformation Adapter that deals with transformation of source meta-model objects to target meta-model objects, the present invention Inverse Transformation Adapter 27 (FIG. 2) deals with transformation of target meta-model objects to source meta-model objects. The Inverse Transformation Adapter 27 holds a map of target meta-model to source meta-model and can make changes to the source model 39 based on what changed in the target model 41. The Inverse Transformation Adapter 27 works in conjunction with a Transformation Adapter 43 (FIG. 3), wherein both share the same pattern for the target model 41. To satisfy the needs of the Inverse Transformation Adapter 27, the Transformation Adapter 43 generates target model elements such that their source elements can be located easily.

One advantage of using a Change-Set Validator 29 and Committer 31 of the present invention is that clients developing a GUI layer around the target model 41 do not have to worry about the origin of the target model (normal model or a model resulting from some transformation). The present invention solution provides a real time inverse transformation solution which is different from existing solutions that provide explicit committing tools to maintain source and target model coherency.

The following details a generic implementation for the above mentioned solution which can handle any source meta-model and any target meta-model. In a preferred embodiment, the Change-Set Validator 29 is implemented as a Rule which gets executed at the end of every transaction on a target model 41. FIG. 2 is illustrative. The change-set Committer 31 is preferably implemented as a Semantic Procedure which gets executed as a result of a change to a target model 41. Usually, Semantic Procedures are used to maintain the semantic sanity of the model and rules are used to run constraints on a model.

With reference to FIG. 2, an example change set 25 includes an instance creation of meta-class ‘TC’ in slot ‘containTac’. The Change-Set Validator 29 rule delegates the validation of the change set 25 to Inverse Transformation adapter 27, at step 2. At illustrated step 3, the change set Committer 31 delegates the committing of change set 25 to Inverse Transformation adapter 27.

More specifically, the Semantic Procedure implemented by the change-set Committer 31 and the rule implemented by the Change-Set Validator 29 only run on models 39, 41 that are results of some transformation. Based on the source and target model 39, 41 for the transformation, the Change-Set Validator 29 rule delegates the validation and the change-set Committer 31 semantic procedure delegates the committing of the change set 25 to a specific Inverse Transformation adapter 27.

Based on the mappings of the source and target meta-models, the specific Inverse Transformation adapter 27 validates the change set 25 and commits the target change set 25 to the source model 39 (FIG. 3). In the illustration of FIG. 2, the specific Inverse Transformation Adapter 27 finds the change set 25 creation of meta-class ‘TC’ in slot ‘containTac’ not supported by the mappings of the source and target meta models. Thus, Inverse Transformation Adapter 27 provides a result of “false” at step 3 and invalidates the change as the result of step 2.

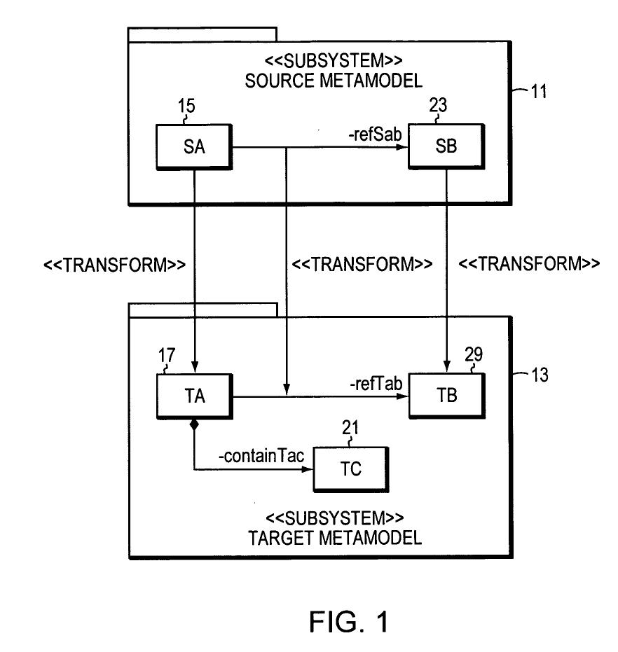

Thus, in the above mentioned example of FIG. 1, if the change set 25 includes an instance creation of meta-class ‘TC’ in slot ‘containTac’ then the Inverse Transformation adapter 27 invalidates the change. Further if the change set 25 includes an instance creation of meta class ‘TB’ in slot ‘refTab’, then the Inverse Transformation adapter 27 creates an instance of meta class ‘SB’ 23 and adds it as a reference in slot ‘refSab’.

If the transformation adapter 43 generates the target model 41 based on the pattern illustrated in FIG. 3, then the Inverse Transform Adapter 27 can easily find the source element from the target element. In turn Inverse Transform Adapter 27 determines the semantic sanity of the change set 25 based on source element. For validated change set 25, Inverse Transform Adapter 27 (or Committer 31) commit the changes (transactions) of the change set 25 to source model 39. As a result, target and source model 41, 39 remain (are maintained) coherent.

In scenarios where a source model 39 is based on some source code and the target model 41 is based on some Software Modeling language (like UML), then the Inverse Transformation adapter 27 can be called a Code Provider. If the code provider cannot translate a change in UML to source code in any form, then the code provider invalidates the change done to the UML model else the code provider emits some form of code to the pertinent source file.

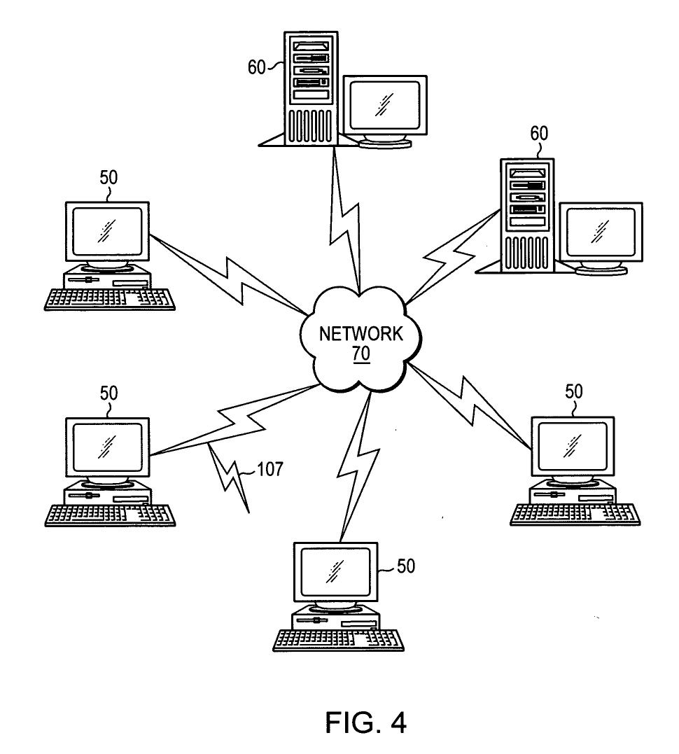

FIG. 4 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

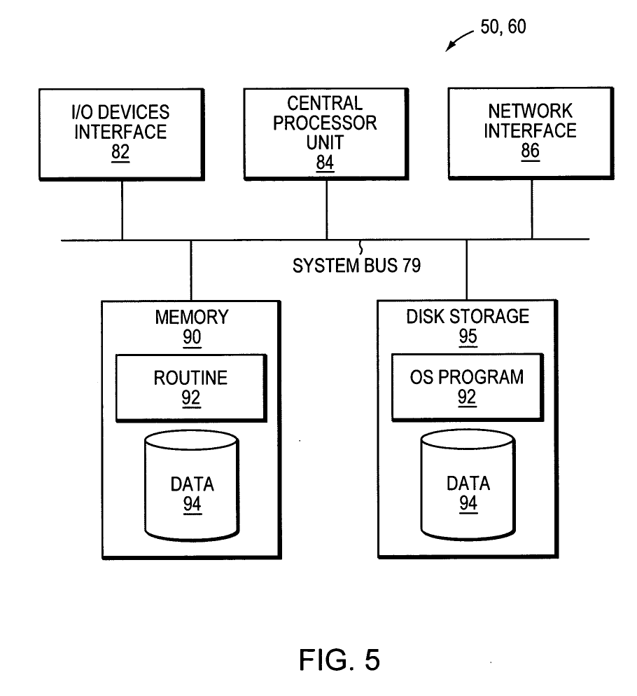

FIG. 5 is a diagram of the internal structure of a computer (e.g., client processor/device 50 or server computers 60) in the computer system of FIG. 4. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network. 70 of FIG. 4). Memory 90 provides volatile storage for computer software instructions 92 and data 94 used to implement an embodiment of the present invention (e.g., change-set Validator 29, Committer 31 and Inverse Transformation Adapter 27 detailed above). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

While this invention has been particularly shown and described with references to preferred embodiments thereof, it will be understood by those skilled in the art that various changes in form and details may be made therein without departing from the scope of the invention encompassed by the appended claims.

For example, the computer architecture and network configuration of FIGS. 4 and 5 are for purposes of illustration and not limitation. Other architectures, configurations, platforms, etc. are suitable for carrying out embodiments of the present invention.

Further model to model transformations (such as those carried out by transformation adapter 43) may be carried out using various techniques. Example techniques are disclosed in U.S. patent application Ser. No. 11/170,384 assigned to the assignee of the present invention and herein incorporated by reference.

What is claimed is:

1. A computer method for maintaining coherent source and target programming models, comprising the computer implemented steps of:
receiving subject changes to a target model, the target model having a respective source model;
validating each of the subject changes to the target model; and
based on said validating the subject changes, committing corresponding changes to the respective source model, including where a subject change is invalidated, then avoiding the subject changes to both the target and source models such that coherency is maintained between the source and target models.

2. A method as claimed in claim 1 wherein the steps of validating and committing are performed at an end of each transaction on the target model.

3. A method as claimed in claim 2 wherein the step of committing further includes, where a subject change is invalidated, then the transaction is rolled back to omit the subject changes to the target model.

4. A method as claimed in claim 1 further comprising providing an Inverse Transformation Adapter to perform said validating and committing, where the subject changes are found to be valid, said Inverse Transformation Adapter mapping target model to source model and making changes to the source model based on changes made to the target model.

5. A method as claimed in claim 4 wherein the Inverse Transformation Adapter works in conjunction with a transformation adapter, the transformation adapter mapping the source model to the target model.

6. A method as claimed in claim 5 wherein the transformation adapter generates target model elements in a manner that enables corresponding source model elements to be easily located.

7. A method as claimed in claim 1 wherein the source and target models are displayed in a visual modeling system.

8. Computer apparatus for maintaining coherent source and target program models comprising:
a change-set indication of changes made to a target model in a respective transaction, the target model having a respective source model;
a validator responsive to the change set indicator for validating the changes; and
a transaction committer receiving results of the validator and based on the validator results committing corresponding changes to the respective source model, where the validator results invalidate any changes of the change set, the transaction committer voiding the changes made to the target model and omitting committing the corresponding changes to the respective source model, such that coherency is maintained between the target and respective source models.

9. Apparatus as claimed in claim 8 wherein at the end of each transaction, the validator validates the changes of the respective change set and the transaction committer performs its operations.

10. Apparatus as claimed in claim 8 wherein an Inverse Transformation adapter implements both the validator and the transaction committer where the changes are found to be valid, said Inverse Transformation adapter mapping target model to source model and making changes to the source model based on changes made to the target model.

11. Apparatus as claimed in claim 10 wherein the Inverse Transformation Adapter works in conjunction with a transformation adapter, the transformation adapter mapping the source model to the target model.

12. Apparatus as claimed in claim 11 wherein the transformation adapter generates target model elements in a manner that enables corresponding source model elements to be easily located.

13. Apparatus as claimed in claim 8 wherein the source and target models are displayed in a visual modeling system.

14. A computer system for maintaining coherent source and target programming models, comprising:
change set means for indicating changes made to a target model in a respective transaction, the target model having a respective source model;
validation means for validating the indicated changes;
committing means for committing corresponding changes to the source model as a function of results of the validation means, where results of the validation means include changes not validated, the committing means voiding the changes made to the target model and preventing committing the corresponding changes to the respective source model, such that coherency is maintained between the target model and respective source model.

15. A system as claimed in claim 14 wherein at the end of each transaction, the validation means validate respective changes and the committing means performs its operations.

16. A system as claimed in claim 14 wherein an Inverse Transformation adapter means implements the validation means and the committing means where the changes are found to be valid, said Inverse Transformation adapter means mapping target model to source model and making changes to the source model based on changes made to the target model.

17. A system as claimed in claim 16 wherein the Inverse Transformation Adapter means works in conjunction with a transformation adapter means, the transformation adapter means mapping the source model to the target model.

18. A system as claimed in claim 17 wherein-the transformation adapter means generates target model elements in a manner that enables corresponding source model elements to be easily located.

19. A system as claimed in claim 14 wherein the source and target models are displayed in a visual modeling system.

20. A computer program product comprising:
a computer usable medium having computer usable program code for maintaining coherent source model and target model for a visual software program modeling system;
the program code including instructions when executed on a computer cause the computer to:
validate changes to a target model, the target model having a respective source model;
based on said validating, commit corresponding changes to the respective source model, where a change to the target model is invalid, then omit the changes to both the target model and the respective source model in a manner such that coherency is maintained between the source and target models.
